(19) United States
(12) Patent Application Publication
(10) Pub. No.: US 2026/0274443 A1
(43) Pub. Date: Sep. 17, 2026

(54) ELECTRO-MAGNETIC LAUNCH SYSTEMSAND METHODS USING HIGH FORCE MAGNETIC LEVITATION

(71) Applicant: Electric Launch, LLC, Santa Barbara, CA (US)

(72) Inventors: Orlo James FISKE, Santa Barbara, CA (US); Michael Richard RICCI, Camarillo, CA (US); Kenneth N. RICCI, Redwood City, CA (US)

(73) Assignee: Electric Launch, LLC, Santa Barbara, CA (US)

(21) Appl. No.: 19/469,325

(22) PCT Filed: Mar. 28, 2024
(86) PCT No.: PCT/US2024/021822

§ 371 Date: Sep. 25, 2025

Related U.S. Application Data
(60) Provisional application No. 63/455,212, filed on Mar. 28, 2023.

(51) Int. Cl. B64G 1/00; B60L 13/00; B60L 13/06; B60L 13/10; B64G 5/00; H01F 5/04; H01F 6/04; H01F 6/06

(52) U.S. Cl. CPC B64G 1/002; B60L 13/003; B60L 13/06; B60L 13/10; B64G 5/00; H01F 5/04; H01F 6/04; H01F 6/06

(57) ABSTRACT

An electrodynamic launching system includes a vehicle having at least one electrically conductive coil arranged to interact with at least one track of ultra-conducting material in a guideway as the vehicle is moved through the guideway. A drive device drives the vehicle at a velocity that induces electrical current in the tracks sufficient to levitate the vehicle and to inhibit collision of the vehicle with the guideway and the tracks by electrodynamic suspension as the vehicle is moved along the tracks, and drives the vehicle at a launch velocity to launch the vehicle from the guideway. The launch velocity is at least as great as the first velocity. A controller controls a release mechanism to release the payload from the vehicle to launch the vehicle from the guideway while the at least one drive device drives the vehicle at a launch velocity.

### CLAIM OF BENEFIT TO PRIORITY APPLICATION

This application claims priority to U.S. Provisional Patent Application No. 63/455,212, filed Mar. 28, 2023, the full disclosure of which is incorporated herein in its entirety.

### GOVERNMENT RIGHTS

This invention was made with government support under contracts FA9550-05-C-0111 and FA9550-07-C-0018 awarded by the U.S. Airforce. The government has certain rights in the invention.

### FIELD OF THE DISCLOSURE

The present disclosure relates generally to magnetic levitation, electrodynamic suspension, and electromagnetic launch systems and methods having such suspension.

### BACKGROUND

Rockets have been used to launch satellites into orbit for over sixty years, and our long experience has made one thing abundantly clear-rocket launch to space will never be cheap. In recent years, factors such as competition, higher launch volumes, the re-use of rockets, and larger rockets have begun to reduce costs, primarily for large payloads. Dozens of satellites are now routinely placed in orbit by a single launch vehicle. But in some cases, the launch of individual small payloads is preferable for scientific or commercial reasons. Examples include, but are not limited to satellites intended for specific or unusual orbits, scientific experiments, and replacements for failed elements of a satellite constellation. A method to provide such launch capability at lower cost than small rocket launch vehicles can be highly preferable and commercially advantageous.

Ground-based accelerators for orbital launch have long been considered a possible alternative to rocket launch with the potential to provide relatively inexpensive access to space, prompting numerous investigators to pursue linear launcher designs. Electrically powered accelerators look particularly attractive, as the energy required to reach orbit, if purchased from the power grid, can be relatively inexpensive. Low Earth Orbit (LEO) is typically at least 200 km above earth's surface, and requires an orbital velocity of almost 8000 meters/sec. To calculate the required energy (e) to reach orbit (neglecting gravity and air drag losses), using a mass (m) of one kilogram, a velocity (v) of 8000 m/s, an acceleration of gravity (g) of 9.8 m/s², and an orbital height (h) of 200 km:

$$e = 1 / 2 {mv}^{2} + mgh = 34 megajoules$$

At a wholesale cost of electricity of $0.04 per kilowatt-hour, for example (one kilowatt-hour equals 3.6 million joules), 34 mega-joules would cost roughly 40 cents. That compares well with small-rocket payload costs that currently reach several thousand dollars per kilogram or more.

But construction of an accelerator has been hindered by the difficulty of creating and controlling the immense power required to accelerate a projectile to launch speed, and the length of the resulting guideway. These numbers can be computed using the equations relating velocity (v), acceleration (a), distance (d), mass (m) and power (p):

$$Distance required to reach launch speed d = {v}^{2} / 2 a ( velocity squared , divided by 2 times the acceleration ) .$$

$$Acceleration power required p = mav ( mass times acceleration times velocity )$$

For example, assuming a total delta-v of 10 kilometers per second is required to achieve orbit (including gravity and air drag losses), if a mass of 3000 kg were accelerated at 10 G to a launch speed of 4 kilometers per second, the distance required for acceleration would be over 82 kilometers and the peak power required for acceleration would be over 1260 megawatts. Constructing a guideway and propulsion to achieve this would be daunting, if indeed it is even possible.

Looking only at the equation p=mav, it would appear that the acceleration power required would decrease as the launch velocity v is decreased. However, this is not the case. The accelerated mass m can include a rocket to further accelerate the payload from launch speed to orbital speed. The fuel required to provide that delta-v is determined by the rocket equation:

$$Δ v = {v}_{e} ln \frac{{m}_{initial}}{{m}_{final}}$$

Where:
νₑ is the rocket exhaust velocity
mᵢₙᵢₜᵢₐₗ is the initial mass of the fully fueled launch assembly
and m_{final} is the mass after the rocket has finished firing

As a result, the required fuel mass increases rapidly as the required rocket delta-v increases. Decreasing the accelerator launch speed rapidly increases the dela-v required of the rocket, thereby increasing the required fuel mass. In fact, the required fuel mass increases much faster than the accelerator launch velocity decreases, thus making the situation worse by increasing the required accelerator power.

Increasing the accelerator launch speed decreases the delta-v required of the rocket and rapidly decreases the required fuel mass, but this does not improve the situation. If the accelerated mass m were reduced to 225 kg, for example, and it was accelerated at 10 G to a launch speed of 8 kilometers per second, the peak power required for acceleration would decrease to 365 megawatts, but the distance required for acceleration would increase to 510 kilometers. A guideway accelerator that long, and requiring that much power, is not practical.

Increasing the acceleration rate from 10 G does not help either, as it directly increases the required acceleration power. In short, linear launch acceleration is currently impractical.

An alternative to linear launch acceleration is circular acceleration. The present inventors previously developed a design for a circular launch accelerator described in the paper entitled, “The Launch Ring-Circular EM Accelerators for Low Cost Orbital Launch”, American Institute of Aeronautics and Astronautics, Inc., Space 2006 Sep. 19, 2006, (https://doi.org/10.2514/6.2006-7279), which is incorporated in its entirety here by reference. A Launch Ring conceptual design as described in this publication is shown in FIG. 1. The Launch Ring 100 in FIG. 1 comprises a maglev sled (not shown in FIG. 1) accelerated by a linear motor (not shown in FIG. 1) around an enclosed, evacuated circular accelerator guideway ring 101 up to several kilometers in diameter. In the system described in that AIAA paper, a superconducting levitation system with superconducting coils in both the sled and the guideway provides centrifugal compensation and vertical levitation, preventing the sled from contacting the passage wall even when subjected to radial accelerations up to several thousand G, as would happen at high launch speeds. A launch projectile is clamped into the sled until it reaches launch speed, whereupon the projectile is released into a tangential launch ramp 102, through an egress hatch and, potentially, into orbit.

While technically possible, a launch accelerator using a design as described in that AIAA paper would be expensive due to the high cost of superconducting cables and the related cryogenic cooling system. It also has a potential failure mode involving “quenching” in the guideway cables, i.e., the cables could drop out of superconducting mode due to the fluctuating magnetic field created by the rapid passage of the maglev sled. Should such a quench event happen, electric current in the guideway coils would disappear, the magnetic field produced by that current would disappear, and the sled levitation forces would disappear, resulting in the possibility that the sled would impact the guideway wall at a high velocity and cause severe damage to the guideway and the sled. For these reasons an alternative design that reduces cost and eliminates the “quenching” failure mode would be highly preferable.

One possible alternative to a superconducting suspension is an electrodynamic suspension. This uses a magnetic field in a moving vehicle to induce current in a track, which then creates suspension force by opposing the field in the vehicle. The difficulty with this approach is the magnitude of the forces and power requirements involved.

For example, given that power=force times velocity, if the target speed for an accelerator is 10 km/sec, each Newton (N) of drag at that speed will cost 10 kW in motor power. Even to keep motor power under 100 MW, a very ambitious goal, the motor thrust must be less than 10,000 N, i.e., 10,000 N times 10,000 m/s equals 100 MW. If the accelerator diameter is five kilometers, the radial acceleration at 10 km/sec is v²/r=10,000²/2,500=40,000 m/s²=4000 G. If the accelerated vehicle weighs 300 kg, its apparent weight (in the radial direction) is then 4000×300=1,200,000 kg or almost 12,000,000 Newtons. The levitation system must counteract that much force, and to limit motor thrust to 10,000 N the lift/drag ratio must be greater than 1200:1. Since power is also required for acceleration, the lift/drag ratio must be even higher. Conventional magnetic levitation systems currently do not provide a lift/drag ratio even close to that level. Most are limited to less than 50:1 Wheeled suspension lift/drag ratios are typically even lower.

In contrast, suspension systems as described herein can be suitable for a Launch Ring accelerator and can provide both very high lift and very low drag.

### SUMMARY OF THE DISCLOSURE

According to certain examples described herein, an electrodynamic suspension guideway forms a circular accelerator tunnel with reduced internal air pressure. A maglev vehicle has superconducting magnets for levitation, and travels around the accelerator tunnel. The maglev vehicle may be propelled by a linear motor in the guideway. Conductive elements or tracks in the guideway are cooled to decrease their electrical resistance, and in some embodiments are fabricated of ultra-conducting, high-purity conductors with a very high Residual Resistance Ratio. Compared to traditional electrodynamic suspension, the conductive elements or tracks described herein provide greatly increased suspension forces and lift-to-drag ratios. The suspension provides vertical force to counteract gravity, and centripetal force to counteract radial acceleration up to several thousand G as the maglev vehicle is accelerated around the circular guideway tunnel. The maglev vehicle carries a launch vehicle that is released at a pre-selected speed, for example, into a tangential launch ramp. The launch vehicle proceeds through the atmosphere at hypersonic speed, and potentially into orbit.

### BRIEF DESCRIPTION OF THE DRAWINGS

FIG. 1 is a diagram of a Launch Ring design.

FIG. 2 is cross section of a basic sheet levitation suspension.

FIG. 3 is a cross section of a maglev sled and payload using an enhanced sheet levitation suspension.

FIG. 4 is an elevation view diagram of a Launch Ring according to an example embodiment.

FIG. 5 illustrates a sled/payload separation sequence.

FIG. 6 illustrates the basic principle of null-flux maglev suspension.

FIG. 7 shows a null-flux coil optimized for the Launch Ring application.

FIG. 8 shows the same coil as FIG. 10, folded for nesting with identical coils.

FIG. 9 shows 16 null-flux coils stacked as they would be in an accelerator guideway.

FIG. 10 is a cross-section view of a Launch Ring accelerator based on a null-flux electrodynamic suspension design.

FIG. 11 is a cross-section diagram of the tracks and vehicle coil for a second embodiment of a null-flux accelerator.

FIG. 12 shows the position of the sled coil and the resultant forces when the sled is moving at high speed.

FIG. 13 shows a cross-section of a maglev sled used in the second embodiment of a null-flux accelerator.

FIG. 14 is a cross-section of an accelerator and sled of the second embodiment of a null-flux accelerator.

FIG. 15 shows the configuration of stability and damping coils used in the second embodiment of a null-flux accelerator.

FIG. 16 shows another embodiment of a guidance system for use in the second embodiment of a null-flux accelerator.

### DETAILED DESCRIPTION OF PREFERRED EMBODIMENTS

Hereinafter, example embodiments will be described in more detail with reference to the accompanying drawings. The present invention, however, may be embodied in various different forms, and should not be construed as being limited to only the illustrated embodiments herein. Rather, these embodiments are provided as examples so that this disclosure will be thorough and complete, and will fully convey the aspects and features of the present invention to those skilled in the art. Accordingly, processes, elements, and techniques that are not necessary to those having ordinary skill in the art for a complete understanding of the aspects and features of the present invention may not be described. Unless otherwise noted, like reference numerals denote like elements throughout the attached drawings and the written description, and thus, descriptions thereof may not be repeated. Further, features or aspects within each example embodiment should typically be considered as available for other similar features or aspects in other example embodiments.

In the drawings, the relative sizes of elements, layers, and regions may be exaggerated and/or simplified for clarity. Spatially relative terms, such as “beneath,” “below,” “lower,” “under,” “above,” “upper,” “front” and “rear” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present invention.

It will be understood that when an element or layer is referred to as being “on,” “connected to,” or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments and is not intended to be limiting of the present invention. As used herein, the singular forms “a” and “an” are intended to include the plural forms as well, unless the context clearly indicates otherwise. It will be further understood that the terms “comprises,” “comprising,” “includes,” and “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “exemplary” is intended to refer to an example or illustration.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

Example embodiments described herein relate to magnetic levitation, electrodynamic suspension, and electromagnetic launch systems and methods having such suspension. In certain examples, high force electrodynamic suspensions described herein utilize materials sometimes called “ultra-conductors”. These are materials, typically metals, that provide exceptionally high conductance, or alternatively, exceptionally low resistivity, when cooled to cryogenic temperatures. Two such metals are ultrapure aluminum and ultrapure copper. Currents induced in these low loss cryogenic conductors can create high force magnetic fields to interact with currents in a superconducting coil contained in a vehicle, and thereby provide powerful suspension forces. Since drag power is directly related to ohmic losses in the conductor, the extremely low losses in the ultra-conductor material can result in extremely low drag. In contrast to superconductors (which exhibit no electrical resistivity when conducting in a superconducting state), an ultra-conductor has some electrical resistance, although a very small resistance, when conducting in an ultra-conducting state. A current can be induced into an ultra-conductor in an ultra-conducting state. On the other hand, a current cannot be induced into a superconductor while it is in a superconducting state.

Two embodiments based on this concept include or employ “ultra-conducting sheet levitation” and “ultra-conducting null flux levitation”.

i. High Force Sheet Levitation

Example embodiments described herein employ electrodynamic suspension (EDS). EDS relies upon induced currents to create repulsive forces for levitation and, in examples that employ curved or circular guideways, to counteract centrifugal forces. In a simplified representation shown in FIG. 2, an EDS system 200 includes a vehicle coil 201 on a vehicle (not shown in FIG. 2) moving over a conductive sheet 202. As the vehicle coil 201 is moved over the conductive sheet 202, the vehicle coil 201 induces electrical currents in the conductive sheet 202, forming repulsive forces as if there were an image coil 203 directly opposing the vehicle coil 201. At sufficient vehicle velocities, the repulsive forces can levitate the vehicle over the conductive sheet 202. Various types of EDS suspensions have been studied for over forty years and are known to produce high lift forces. Typical EDS suspensions have employed tracks fabricated of copper or aluminum designed to operate at ambient temperatures. However, conventional implementations of EDS suspensions tend to produce high drag, resulting in lift/drag (L/D) ratios typically in the 10-20 range or less, with drag decreasing as speed increases.

Both the lift and the L/D ratio of a sheet levitation system are related to the conductivity of the sheet conductor. As the conductivity improves, the induced current becomes stronger, creating more repulsion, and the resistive losses decrease, thereby decreasing drag. To be more specific, suspension force F_{L} produced by a vehicle coil interacting with its “image” can be estimated with the equation:

$${F}_{L} = {F}_{I} \frac{{v}^{2}}{( {w}^{2} + {v}^{2} )}$$

Where:

The force produced by the image coil

$${F}_{I} = \frac{{μ}_{0} {I}^{2}}{4 π h}$$

$$w = 2 / {μ}_{0} σ h$$

The permeability constant μ₀ is 1.256637062×10⁻⁶
I is the current in the vehicle coil
h is height of the vehicle coil over the conductive sheet
σ is the conductivity of the sheet

If σ increases, w decreases. If σ could be increased enough, w² would become very small,

$$\frac{{v}^{2}}{( {w}^{2} + {v}^{2} )}$$

would approach 1, and the repulsive force produced by the image coil would approach the force that would be produced if it were an actual superconducting coil. This would result in a high suspension force.

The drag force is:

$${F}_{D} = \frac{w}{v} {F}_{L}$$

Substituting for w:

$${F}_{D} = \frac{2}{{μ}_{0} σ hv} {F}_{L}$$

Here again, if σ could be increased enough,

$$\frac{2}{{μ}_{0} σ hv}$$

would have a small value and drag would become a small fraction of lift, decreasing even further as velocity v increases. This can, in fact, be accomplished.

The reciprocal of conductivity is resistivity, and the resistivity of ordinary aluminum is about 2.8×10⁻⁸ Ω-m at 293K. When cooled to cryogenic temperatures it drops by a factor of 20-30. However, in high purity form, aluminum can have a residual resistance ratio (RRR) of more than 5000, i.e., its resistivity decreases by up to a factor of 5000 at cryogenic temperature. Below 30K it can drop to as low as 5.6×10⁻¹² Ω-m. High purity, oxygen-free copper is almost as good. Such high-purity materials are sometimes called “ultra-conductors”.

The Launch Ring design described in the above-cited AIAA paper showed how to construct superconductor-based accelerator guideway systems that operate at 1.9K. However, ultra-conductor operating temperatures near 30K, or even 77K, are significantly easier to reach and maintain than the temperatures required for the superconductor-based system described in the AIAA paper. Moreover, in some embodiments the Launch Ring can operate at speeds of up to 36,000 kph.

These factors have a significant effect on drag and the L/D ratio and make sheet levitation a far more viable option for circular launch acceleration, as shown in the design example below. When combined with cryogenic accelerator construction techniques, sheet levitation eliminates the possibility of a quench in the track conductors completely, since superconducting tracks are no longer required, and greatly simplifies accelerator construction. In place of superconducting stator cables, a thin sheet of cryogenically cooled high, purity aluminum is employed, which is readily available, considerably less expensive than superconductors, and easy to form into the requisite structures. This approach places an additional heat load on the cooling system due to eddy current heating in the levitation sheet. But the additional heat load is largely offset by higher operating temperatures of ultra-conductor materials, as compared to superconductor materials. For example, an ultra-conductor operating temperature of 20K requires only one-tenth of the power necessary to produce cooling at a superconducting operating temperature of 1.9 K. Certain examples can also reduce heat conduction or gain from outside the accelerator by employing a simplified structure compared to the superconducting approach. In particular examples, any excess heat can be handled by cryogen stored prior to launch, to further reduce peak power requirements during launch.

In a circular accelerator, centripetal force will increase with the square of the speed, increasing the required suspension force. While other embodiments may include other parameter values, as an example to assist with the present disclosure, the parameter values shown in Table 1, below, are used:

TABLE 1
Sheet Levitation at Ambient Temperature

| Accelerator Radius | 2 | km |
|---|---|---|
| Vehicle coil current | 600,000 | amps |
| Vehicle coil length | 3 | m |
| Vehicle coil width | 0.5 | m |
| Track thickness | 1 | mm |
| Track resistivity @ 293K | 2.65 × 10⁻⁸ | Ω-m |
| L/D Ratio @ 10 km/sec | 237 | |
| Drag Power @ 10 km/sec | 316 | MW |

With the above-noted parameter values, the L/D ratio is up to 237 at peak speed. However, this accelerator with two coils, each having a drag power of 316 MW, would exhibit a total drag of 632 MW at 10 km/sec. These numbers change radically when the track operating temperature and track resistivity is reduced, as shown in Table 2 below:

TABLE 2
Sheet Levitation at Cryo Temperature

| Track resistivity | 5.62 × 10⁻¹² | Ω-m |
|---|---|---|
| L/D Ratio @ 10 km/sec | 16,400 | |
| Drag Power @ 10 km/sec | 4.6 | MW |

With the parameter values in Table 2, the L/D ratio significantly increases and drag power drops to a total of 9.2 MW for two coils. In certain examples, the track may have a thin layer or sheet (such as, but not limited to a 100-micron layer) of 99.999% pure, cryogenically cooled aluminum. The costs of the materials for such a track can be reasonable, and there are no irresolvable fabrication or assembly issues. In other examples, other suitable materials such as, but not limited to copper, and other suitable purity levels that exhibit ultra-conducting behavior at cryogenic temperatures may be employed. Such other purity levels may include, but are not limited to, other levels at or above 99.9% purity. Also, in other examples, other suitable layer thicknesses may be used.

In actual operation, L/D ratio is unlikely to be as high as shown in Table 2, due to electrodynamic effects that decrease electric current penetration into the sheet and thus increase the apparent resistance. However, the L/D ratio would, nevertheless, be far higher than in conventional maglev suspensions.

To minimize the total heat load, the acceleration period should be kept reasonably short. A 25 MW motor, for example, can accelerate a 300 kg sled to 10 km/sec in about 15 minutes.

In other embodiments the accelerated mass can be considerably larger to accommodate a larger payload having a rocket that provides additional propulsion power after the payload is launched. However, because the rocket provides additional propulsion power, the launch speed can be considerably lower, allowing higher operating temperatures.

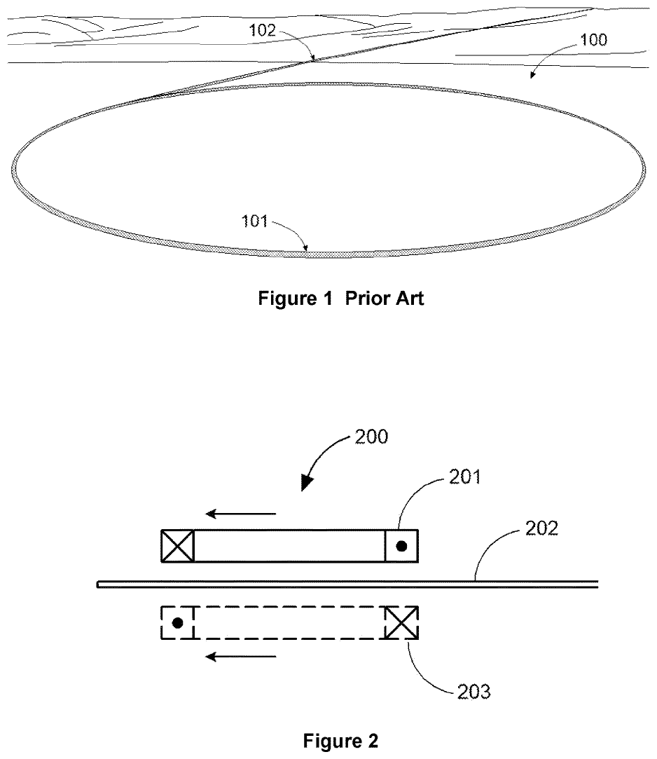

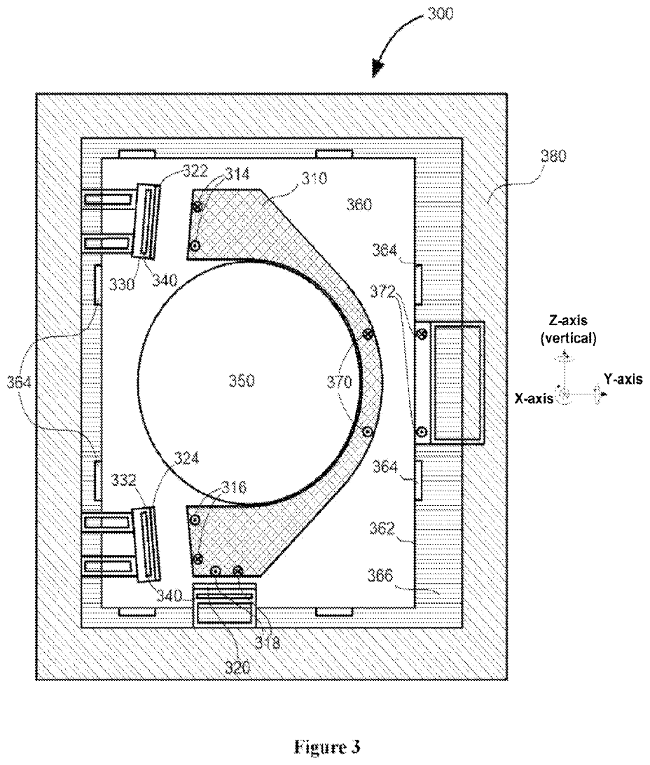

FIG. 3 shows a cross-section of an example embodiment of an electrodynamic launching system 300, using repulsion forces of sheet levitation in an EDS Launch Ring design. The system 300 includes a vehicle (shown as a sled 310) located within a guideway that has at least one electrically conductive track. The guideway and track(s) have a lengthwise dimension (which, in certain examples, may extend in a circular shape as shown in FIG. 1), where the cross-section of FIG. 3 is perpendicular to the lengthwise dimension (or a radial cross-section). In certain examples, the guideway may be formed as an enclosed, tube-like structure and may be connected to a vacuum source to evacuate the tunnel and form a substantial vacuum within the tunnel.

As described herein, the sled 310 has at least one electrically conductive coil arranged to interact with each electrically conductive track to induce electrical current in each track as the vehicle is moved along the lengthwise dimension of the track. In particular examples, each of those electrically conductive coils on the sled is a superconducting coil made of a superconducting material forming a closed loop superconducting circuit. In the example in FIG. 3, the sled 310 includes an upper repulsion coil 314 and a lower repulsion coil 316, each fabricated of an Nb₃Sn low temperature superconductor, a YBCO high temperature superconductor, or any other comparable superconductor. Each of the repulsion coils 314 and 316 carries a high amperage direct current. For example, prior to acceleration of the sled 310 for launch, each repulsion coil 314 and 316 may be charged with the high amperage direct current by an electrical power source associated with the guideway and located off of the sled 310. The charging power source may be coupled to the coils 314 and 316 on the sled 310 to charge the coils before acceleration for launch, and once the coils 314 and 316 are cooled to a temperature at or below superconducting temperature (as described below). Once the coils 314 and 316 are sufficiently charged, the coils (and sled) are disconnected from the charging power source. The coils 314 and 316 are maintained at or below superconducting temperature to maintain the charge in the coils, after disconnection from the power source and for the duration of the launch operation. In certain examples, superconducting coil charging may be carried out based on principles similar to systems known for charging by superconducting flux pumps as used in magnetic resonance imaging machines or other applications, however, with sufficient charging power for the launch operations described herein.

In certain examples, the coils 314 and 316 are cooled a few degrees below their operational temperature prior to acceleration for launch, and are sufficiently insulated to stay cold inside the vacuum tunnel of the guideway during acceleration and for the duration of launch operations, without requiring further cooling during launch. In those examples, the superconductor repulsion coils 314 and 316 may be cooled by cryogenic cooling fluid from a cooling fluid source associated with the guideway and located off of the sled 310, before the sled is accelerated in the guideway. Before acceleration for launch, the cooling fluid source may be coupled to the sled 310 to supply cooling fluid to ducts (not shown) in the sled that are arranged to direct the cooling fluid sufficiently close to the coils 314 and 316 to cool the coils below a superconducting operation temperature. Also before acceleration for launch, and once the coils 314 and 316 are at a temperature at or below superconducting temperature, the cooling fluid source is disconnected from the sled 310. The coils 314 and 316 may be thermally insulated sufficient to maintain a temperature at or below superconducting operation temperature after disconnection from the cooling fluid source, for the duration of the launch operation. In those examples, a cryogenic cooling fluid source or system need not be stored on the sled 310 during launch. However, in other examples, the sled 310 may carry a cryogenic cooling source and system that cools the repulsion coils 314 and 316 during launch operations.

In the example in FIG. 3, the sled also carries a vertical repulsion coil 318 (such as a superconducting coil configured, charged and cooled as described above), and vertical suspension is provided by EDS interaction of the vertical repulsion coil 318 and a conductive plate 320 of a track located beneath the sled 310. In other embodiments the vertical repulsion coil 318 is not included, and vertical suspension is derived from the EDS interaction of the lower repulsion coil 316 and the conductive plate 320 beneath the sled 310. Because EDS does not provide sufficient force to lift a vehicle until a “take-off” speed is reached, which can be over 100 kilometers per hour, a low-speed support system such as, but not limited to sliders or wheels (not shown) may be included in the vehicle, in the guideway, or in a carriage to support the moving vehicle in the guideway until a sufficient take-off speed is reached.

Each of the conductive plates may include a flat, plate-shaped body of ultra-conducting material that extends in a lengthwise dimension corresponding to the lengthwise dimension of the guideway. In other examples, each conductive plate may include a layer of ultra-conducting material on a structure having a lengthwise dimension corresponding to the lengthwise dimension of the guideway. In particular examples, each conductive plate may be mounted in the guideway by support structure and may be electrically insulated from the support structure and other components in or of the guideway. In the example of FIG. 3, the upper conductive plate 322 and the lower conductive plate 324 are plate-shaped bodies that are surfaced with ultra-conducting material and are tilted slightly from vertical (e.g., the z axis) such that the surface of the conductive plate 322 is angled downward relative to a horizontal plane (e.g., the plane defined by the x-y axis) and the surface of the conductive plate 324 is angled upward relative to the horizontal plane, as shown. The upper and the lower repulsion coils 314 and 316 in the sled are arranged to induce electrical current into the upper conductive plate 322 of the upper track and into the lower conductive plate 324 of the lower track by EDS interaction, as the vehicle is moved along the lengthwise dimension of the tracks.

As the sled speed increases, radial force and the tilted plates will tend to move the sled 310 upward toward the vertical center between the two conductive plates 322 and 324, decreasing the vertical lift required from the conductive plate 320 beneath the sled. In other embodiments the surfaces of the upper and lower conductive plates 322 and 324 face radially inward and are not tilted, and vertical lift is provided entirely by the conductive plate 320 beneath the sled. In the example in FIG. 3, the conductive plates 322 and 324 are mounted on track structures 330 and 332 located within the guideway. The conductive plate 320 may be mounted on a similar track structure. Each track structure may be fabricated of strong, stiff material having low thermal conductivity, such as, but not limited to carbon fiber, to prevent heat conduction into the cold chamber and withstand the massive forces applied when the sled 310 reaches high speed. In particular examples, the conductive plates 320, 322 and 324 are cooled by cryogenic fluid such as, but not limited to liquid helium flowing through primary coolant channels 340. In embodiments designed to operate at a higher temperature and a launch speed significantly lower than orbital speed, the cryogen may be liquid nitrogen or other suitable coolant fluid.

A payload 350 may include any suitable projectile or device designed to be projected at a high velocity. In certain examples, the payload 350 may include one or more of a launch rocket, a space vehicle, an air vehicle, or any combination thereof. The payload 350 is carried by the sled 310, and is held against radial forces by a high-strength composite sling or other containment mechanism (not shown). At launch speed a release mechanism releases the payload into a launch ramp.

The containment and release mechanism may be controlled by an electronic controller on the vehicle (or on the payload), configured to hold the payload 350 on the vehicle as the vehicle is moved through the guideway at high velocities, and to controllably release the payload from the vehicle to launch the payload from the guideway while the at least one drive device drives the vehicle at a launch velocity. In some examples, the containment and release mechanism and the electronic controller may include a programmable processor and a mechanical, electromechanical, magnetic or electromagnetic latch or lock that has a first state for holding the payload on the vehicle and a second state for releasing the vehicle. Certain nonlimiting examples of release mechanisms are described in the above-cited AIAA paper.

In particular examples, the accelerator tunnel 360 of the guideway is evacuated to a sufficiently low pressure to prevent excessive sled drag or heating as the sled approaches the design launch speed. Also in particular examples, the accelerator tunnel 360 is lined with a heat shield 362 to prevent infrared heat emissions from raising the sled temperature. The heat shield 362 may be cooled by secondary coolant channels 364, using liquid nitrogen or other suitable coolant fluid, and may be protected from outside heat by insulation 366.

At least one drive device may be configured to propel the sled 310 along the lengthwise dimension of the track(s) at a take-off velocity or levitation velocity to induce electrical current in the conductive sheet(s) of the track(s) sufficient to levitate the vehicle by electrodynamic suspension as the vehicle is moved along the lengthwise dimension of the track(s), and at a launch velocity to launch the vehicle from the guideway. The launch velocity is at least as great as the take-off or levitation velocity. In the example in FIG. 3, a drive device includes a sled motor coil 370 on the sled and one or more motor stator coils 372 on the guideway. In particular examples, the sled motor coil 370 is made of a superconducting material as described herein. In that example, propulsion is provided by superconducting sled motor coil 370 carrying high amperage direct current interacting with the motor stator coil(s) 372 mounted in the accelerator tunnel wall structure 380. In that example, the motor stator coil(s) may be coupled to suitable power and control electronics (not shown), to provide a controlled electromotive force to drive the sled 310 at the desired velocities.

The suspension forces produced by cryogenic sheet levitation are roughly the same magnitude as those calculated for a superconducting suspension. For example, the two sled coils in the model used to compute the suspension operating characteristics in the “EDS at Cryo Temperature” table each produce 7.5 meganewtons of suspension force at a sled speed of 10 kilometers per second, a levitation gap of 3.2 cm, and a coil current of 600 KA. Higher currents in superconducting sled coils are feasible, which offers the possibility of acceleration rings under 2 km in radius for launch speeds approaching 10 kilometers per second.

In a Launch Ring system with a hypersonic launch speed in the range of two to four kilometers per second (7,200 to 14,400 kph), the payload may include, but is not limited to, a rocket including a rocket engine, fuel and oxidizer, a flight control system, and a space vehicle. The space vehicle may include an orbital vehicle and a second rocket motor to adjust the orbital parameters once the vehicle reaches orbital altitude. In other embodiments, the payload could include an air vehicle for high altitude, high-speed test programs. If the launch speed is even higher, in some cases even beyond orbital velocity, the payload may include a vehicle capable of surviving passage through the atmosphere at such speed, as described in the above-cited AIAA paper. In particular examples, the payload may include a small rocket engine capable of providing the necessary delta-v to place the final space vehicle into the desired orbit. Also in particular examples, launch vehicles or other payloads may include protection in the form of a sabot, described further below and in the above-cited AIAA paper.

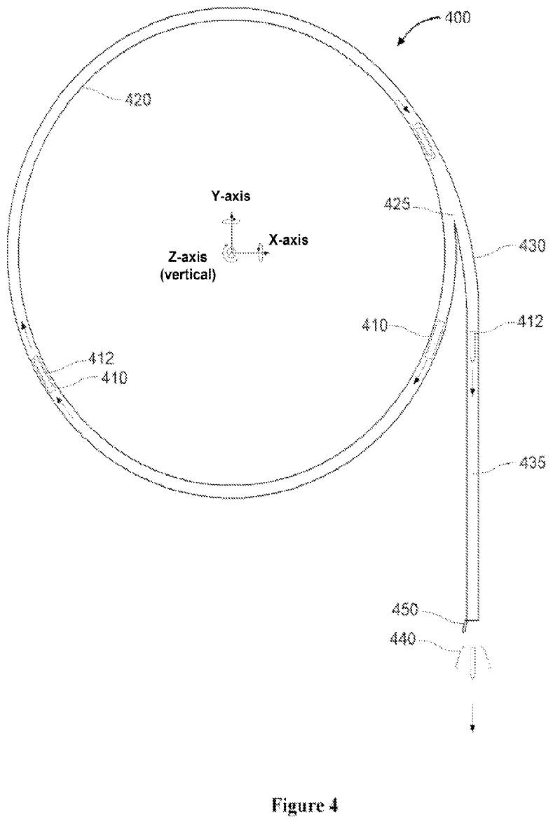

FIG. 4 is an elevation view diagram of a Launch Ring electrodynamic launching system 400 according to an example embodiment. In an example launch sequence, a sled 410 and a payload 412 are accelerated around an accelerator ring 420 to a launch speed. The sled 410 and the payload 412 may correspond to the sled 310 and the payload 350, or to other sleds and payloads as described herein.

As the sled 410 enters a release zone 425 at full launch speed, the payload 412 is released into a transition curve guideway 430 that gradually changes from the curve radius of the ring-shaped guideway of the accelerator ring 420 to a straight tunnel. In other embodiments a tangential tunnel segment is used in place of a transition curve. The tunnel then begins to curve upward, forming launch ramp 435 to elevate the launch angle closer to optimum for launch. In certain examples, a sabot 440 is provided to protect the payload from damage as it slides along the ramp. In particular examples, the launch ramp 435 or the sabot 440 (or both) may include a low-friction barrier such as, but not limited to a polycarbonate, thermoplastic material such as Lexan™ or the like, as an ablation coating or layer, between the payload and the ramp. As the payload 412 approaches the end of the launch ramp 435, an egress hatch 450 opens over the end of the launch ramp 435. In certain examples, the end of the launch ramp 435 may include a membrane to prevent air from entering the evacuated tunnel. As soon as the payload bursts through the membrane, the hatch 450 may be controlled to slam shut and minimize loss of vacuum in the guideway, in preparation for the next launch. The sabot 440 may be controlled to separate from the payload after the payload passes through the end of the launch ramp, and the rocket may be controlled to fire its engine to further propel the payload 412 onto its designated trajectory. The control of the operation of the hatch 450 and of the release of the sabot 440 may be carried out by one or more electronic control systems associated with the guideway, the sled, or both. After releasing the payload 412, the sled 410 may be controlled by the drive device(s) to continue around accelerator ring 420 and to decelerate to a stop, for example, for reloading in preparation for the next launch.

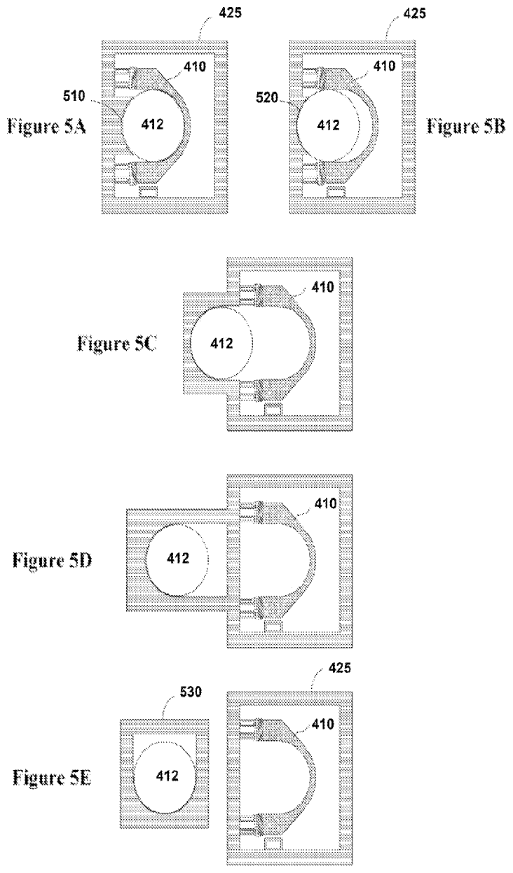

FIGS. 5A-E illustrate an example of a sled/payload separation sequence according to the embodiment of FIG. 4. As the sled 410 enters the release zone 425 at full speed in FIG. 5A, the sled 410 encounters a raised landing zone 510 in the side of the release zone 425. Due to the speed of the sled 410 and the curvature of the ring, payload 412 will be under heavy lateral G-loading at this point. Depending on speed and the ring radius of the guideway, this loading could be up to several thousand G's. When payload 412 is released, radial acceleration moves it away from sled 410 until it contacts the landing zone 510. The distance the payload 412 moves from sled 410 to the landing zone 510 may be small, such as, but not limited to a few millimeters or less to prevent the impact speed from climbing high enough to damage payload 412. After contact, payload 412 slides along the transition curve 520, as shown in drawing B, as it gradually moves away from the center of release zone tunnel 425. In drawings of FIGS. 5C, 5D and 5E, transition curve 520 and payload 412 continue to move away from sled 410 until the launch tunnel 530 separates completely from release zone tunnel 425 and launch tunnel 530 stops curving horizontally and begins to curve upward to provide the desired launch angle. An ablation or other low-friction surface, such as, but not limited to a polycarbonate, thermoplastic material such as Lexan™ or the like, protects the payload wherever it contacts the tunnel surface. As the launch tunnel 530 transitions from a lateral curve to an upward curve, the contact area moves from the lateral surface to the bottom surface of the payload. In other embodiments, the payload and the launch tunnel may be configured such that the payload rotates along its axis to keep the G-loading oriented in the “payload vertical” direction, removing the need for the payload to be designed to accommodate high G-forces in more than one direction.

In other embodiments, the launch tunnel transition curve is eliminated in favor of a tangential launch tunnel. In these embodiments the payload does not contact the lateral tunnel surface and instead free flies into the launch ramp. In still other embodiments, a launch ramp is not included, and the payload exits the launch tunnel on a horizontal trajectory. The payload may include one or more control surfaces such as, but not limited to wings, ailerons, or the like, to interact with the atmosphere and direct the vehicle onto a proper trajectory.

If a Launch Ring is constructed off planet, for example in space or on the Moon, where there is no atmosphere, the payload may include thrusters or rocket motors to modify the trajectory.

ii. Ultra-Conducting Null-Flux Levitation

While ultra-conducting sheet levitation provides the basis for a simple but highly capable launch accelerator design as described above, it has characteristics that could be further improved. One of these is the interaction of the suspension and the motor. Again referencing FIG. 3, as the sled 310 accelerates, radial acceleration forces the sled closer to the lateral sheet tracks 322 and 324, and increases the lateral suspension force. However, at the same time the sled 310 moves farther from motor windings 372, decreasing their effectiveness. Accordingly, in particular examples, variation of sled “flying height” is controlled to be as small as possible, i.e., exhibit high stiffness to avoid large gap variations. Sheet tracks can show relatively low stiffness leading to a large motor-to-winding gap during high-speed operation, when the motor should be most effective.

Accordingly, an alternative EDS suspension embodiment that allows more efficient motor operation employs principles of “null-flux” levitation-which can provide even higher L/D, higher stiffness, and a better motor geometry than sheet levitation. Principles of null-flux levitation can also improve fault tolerance. In contrast, in the repulsive configuration of the sheet track system shown in FIG. 3, if the superconducting sled coils were to quench, the vehicle could crash into the track at high velocity and damage components of the system. However, a null flux configuration can be configured such that a vehicle failure is far less likely to damage the track.

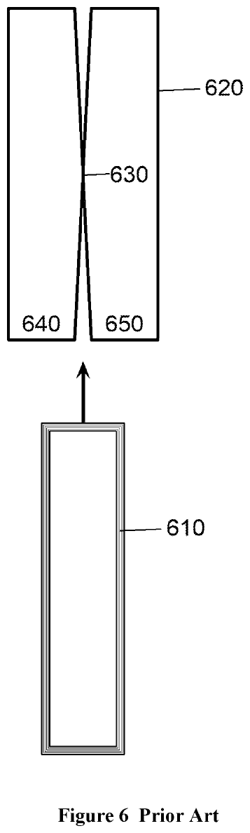

FIG. 6 is a simplified representation illustrating certain basic principles of null-flux levitation as employed in the alternative EDS suspension embodiments described herein. In example embodiments using null-flux levitation, a charged superconducting coil 610 on a sled (such as the sled 310 or 410) moves past a figure-8 null-flux coil 620 in a guideway (such as the guideway described herein). If the moving coil 610 crosses the null-flux coil 620 at its center, i.e., symmetrically over the coil crossover 630, the moving coil 610 will induce opposite voltages in the two lobes 640 and 650 of the null-flux coil 620. These voltages will cancel each other out, resulting in no current flowing through null-flux coil 620 and no force on superconducting coil 610. If superconducting coil 610 crosses null-flux coil 620 off center, however, it will induce a larger voltage in one lobe than the other, resulting in current flow within the null-flux coil 620, and a magnetic field that interacts with the magnetic field of superconducting coil 610 to create a force pushing the superconducting coil 610 back toward the centerline of null-flux coil 620. A suspension of this type was used in the Japanese MLX-01 maglev train.

At ambient temperatures and using conventional copper wire, null-flux suspensions are known to provide high lift force and L/D ratios of more than 20. Replacing the copper wire with ultra-conducting wire will improve performance, but as with sheet track it has limitations. Sheet track performance is limited by skin depth. As the sled speed increases, the magnetic field penetration into the track decreases, increasing the effective track resistance and power losses, and limiting the L/D ratio. Skin depth and proximity effects can impair null-flux suspensions, but this can be counteracted to a large degree by using a multistrand wire such as, but not limited to a Litz wire. This is a type of multistrand wire is designed to reduce skin effect and proximity effect losses in conductors at frequencies up to about 1 MHz. A suitable multistrand wire or Litz wire may have many thin wire strands, individually insulated, and twisted or woven together in a specific pattern to equalize the proportion of the overall length over which each strand is at the outside of the conductor. This has the effect of distributing the current equally among the wire strands, reducing the resistance. Analysis shows L/D ratios exceeding 20,000 may be possible, with reasonable assumptions on Litz wire size using 99.999% pure aluminum cooled to cryogenic temperatures. Alternatively, less expensive high purity copper or aluminum can be used, or the track could be run at a higher temperature, and still achieve high L/D ratios.

In example Launch Ring system embodiments, one goal may be to maximize the levitation force provided by the track in the guideway interacting with superconducting coils in the sled, while minimizing the weight of the sled to allow the largest payload and smallest accelerator ring possible, thus minimizing cost. In addition, the guideway track may be configured to minimize variation in the magnetic field seen by the sled coils as the sled moves past guideway track coils at high speed, to avoid quenching the superconducting coils. In certain examples, this can be accomplished by using nested, overlapping null-flux coils that are electrically insulated from each other.

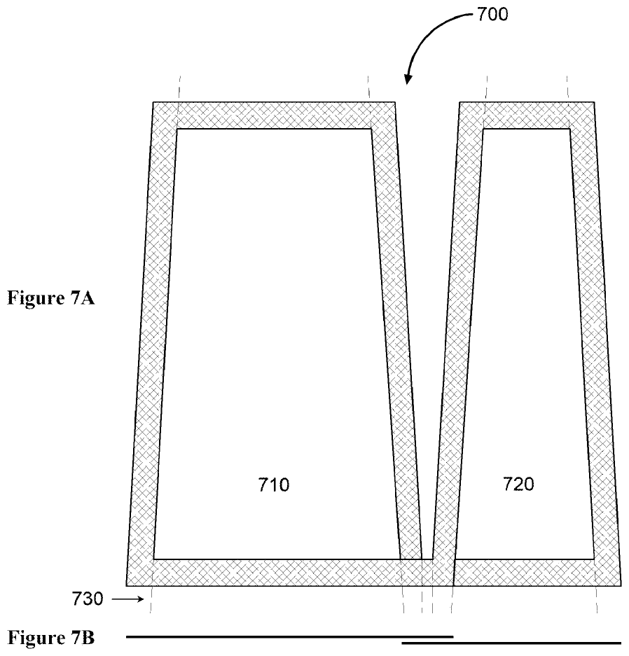

FIGS. 7A and 7B show a top-down view and a side view of a null-flux coil 700, configured for a Launch Ring system. In the null-flux coil 700, the coil lobes 710 and 720 are not symmetric. More specifically, the lobe 710 of the figure-8 is larger than the lobe 720. In this example, the suspension is used to create solely inward radial force, as outward radial force is not required. The shape of the coils may be modified to decrease the length of the loops (and hence resistance and drag) as much as possible while still capturing as much flux from the vehicle as possible. A Mathcad worksheet was developed that calculated the expected levitation forces for a parameterized vehicle and null flux coil configuration. A nonlinear optimization algorithm was then employed to solve for the geometry that gave the best L/D ratio. The result is that one of the lobes is smaller, decreasing the losses and drag more than it decreases the flux linkage from the vehicle to the coil. In particular examples of the null-flux Launch Ring system, a flat multistrand wire (such as, but not limited to a Litz wire) is configured in a figure-8 loop and is folded and nested with successive figure-8 loops of the multistrand wire to form a continuous track. Dashed lines 730 indicate where the coil will be folded.

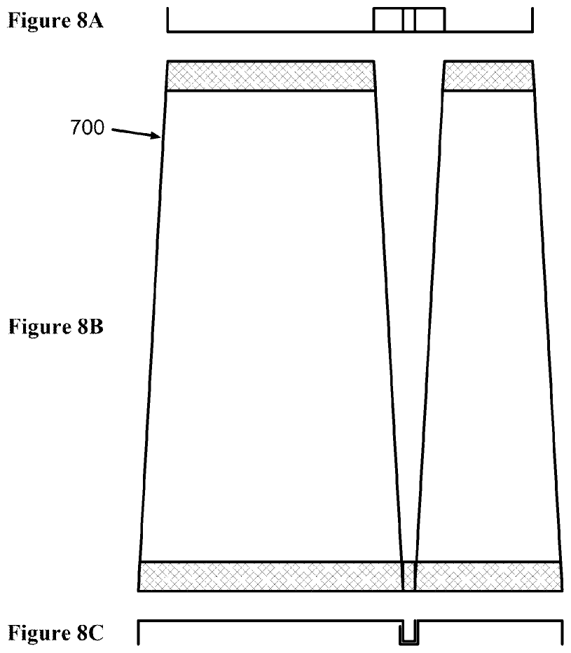

FIGS. 8A-8C show a first end view, a top view and a second end view of the null-flux coil 700 of FIG. 7, but now folded in preparation for nesting with other identical coils. In particular examples, each track in the guideway includes an array of a plurality of nested null-flux coils 700 that extend along the lengthwise dimension of the track.

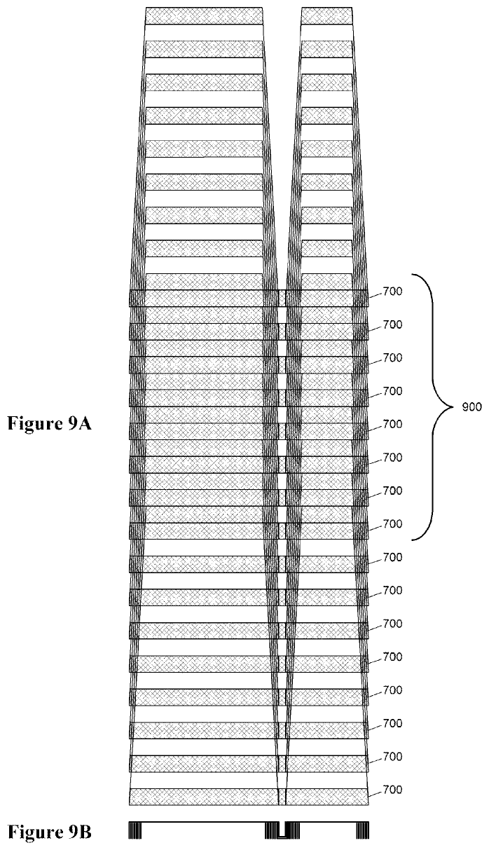

FIGS. 9A and 9B show a top view and an end view of an arrangement of 16 null-flux coils 700 stacked and nested to extend along a lengthwise dimension (the vertical dimension of FIG. 9) corresponding to the lengthwise dimension of an accelerator guideway as described herein. Each null-flux coil 700 is electrically insulated relative to each other null-flux coil 700 in the guideway array. While only 16 nested coils 700 are shown in FIG. 9, in particular examples, the overlapping, nested null flux coils 700 form a continuous track along the entire lengthwise dimension of the guideway. In a circular guideway as described herein, the continuous track would appear like the center section 900, with no gaps in coverage.

In particular examples, the null-flux coils 700 are made of ultra-conducting aluminum, copper or other ultra-conducting material at a cryogenic temperature as described above. In those or further examples, the null-flux coils 700 are made of insulated, multistrand wire or Litz-wire ribbons.

As an example, each track coil may be composed of a high purity 99.995% aluminum or 99.99% copper, braided Litz wire ribbon, where each ribbon is 2 mm×50 mm. Up to 20 ribbons may be overlapped for total thickness 40 mm×width 50 mm, and potted to endure up to 20 MPa compression. The array of overlapping null-flux coils may be over-wrapped with a sufficient carbon fiber composite to hold them in place against up to 12 Megapascal magnetic loads that can attract the track coils toward the vehicle coils during operation. In other examples, other suitable ultra-conducting materials and null-flux coil configurations may be employed.

Three independent mathematical methods were used to refine and independently confirm suspension force estimates for the null-flux coil systems as described herein:

According to method 1, a calculation of the mutual inductance between vehicle coil and track coils, and the self-inductance of the track, was performed by direct numerical integration in Mathcad using the Biot-Savart Law to derive magnetic fields from currents. The current excited in the track was then computed from these inductances, and the resulting forces were computed in Mathcad by direct numerical integration of the Biot-Savart Law for the magnetic field from the track and the Lorentz law for forces on the vehicle coils in that magnetic field.

According to method 2, a Finite Element Analysis (FEA) used a 2-D model to compute the time-dependent magnetic flux through the vehicle coil and track coils and to derive the resulting current excited in the track. Then a 3-D FEA model was used to compute the centripetal suspension force and tangential drag force exerted on the vehicle by these time-dependent currents as the vehicle passes each set of null-flux loops in the track.

According to method 3, analytic expressions were developed using integral and differential vector calculus to approximate the self-inductance of the track loops and the mutual inductance of the vehicle and track loops as a function of the relative positions of the vehicle and track coils. These approximations were integrated numerically in time using MATLAB to calculate the time-dependent magnetic flux coupling, excited track currents, and resulting Lorentz forces on the vehicle.

These three methods were used to develop a variety of parameters, geometries, and limiting cases. The three methods independently confirmed that a system having a vehicle and track with the following parameters can produce 8 to 11 Meganewtons of centripetal force, sufficient to hold a 300 kg vehicle in a Launch Ring of radius 2800 to 3800 meters, at launch velocity 10 km/second:

$$Number of vehicle coils = 2$$

$$Each vehicle coil length = 2. meters$$

$$Vehicle coil width = 0.5 meters$$

$$Vehicle coil current = 1 million amp - turns$$

$$Track coil length = 2. meters$$

$$Track coil width ( major loop ) = 0.5 meters$$

$$Track coil width ( flux nulling loop ) = 0.2 meters$$

$$Track coil center to vehicle coil center = 0.09 meters$$

2 sets of track coils (1 above and 1 below the vehicle)
Track conductor construction: 2×50 mm ribbon of Litz wire formed from 25 turns of 2×2 mm
Litz bundle of approximately 4,000 strands of AWG 50 (OD 25 micron) 99.95% copper or 99.99% aluminum wire.

The three estimation methods each indicate that a peak current in the range of 320 to 440 kA will be excited in null-flux track loops with these parameters, providing sufficient lift.

For this track design where null-flux loops overlap each other and are spaced at intervals of 10 cm along the track, the FEA model shows that current is distributed among at least five adjacent track loops at a time, with the null-flux loops most directly under the vehicle carrying about 40% of the current, and the nearby loops carrying the other 60% of the current. The net force on the sled is the sum of the forces produced at any time by all the excited track coils and is nearly constant.

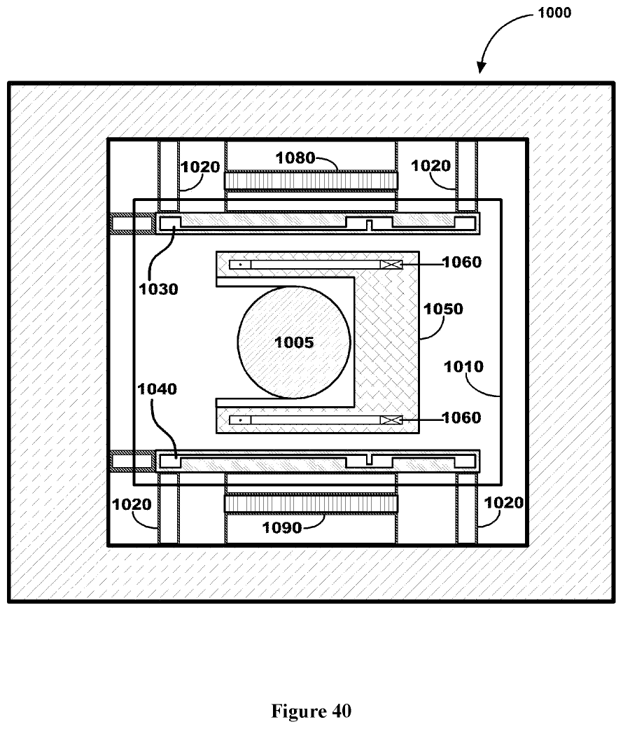

FIG. 10 shows a cross-section of an example embodiment of an electrodynamic launching system 1000, using repulsion forces of null-flux levitation in an EDS Launch Ring design. Similar to the guideway described for FIG. 3, the guideway and track(s) in FIG. 10 have a lengthwise dimension (which, in certain examples, may extend in a circular shape as shown in FIGS. 1 and 4), where the cross-section of FIG. 10 is perpendicular to the lengthwise dimension (or a radial cross-section). Also similar to FIG. 3, in certain examples, the guideway in FIG. 10 may be formed as an enclosed, tube-like structure and may be connected to a vacuum source to evacuate the tunnel and form a substantial vacuum within the tunnel.

The system 1000 in FIG. 10 includes many features of the sheet levitation accelerator system 300 shown in FIG. 3, such as a heat shield 1010, support struts 1020, and cooling channels (not shown). However, in the configuration of FIG. 10, a first null-flux track coil 1030 is arranged above and a second null-flux track coil 1040 is arranged below a vehicle or sled 1050. The first and second null-flux track coils 1030 and 1040 interact with a superconducting coil 1060 in the top of the sled 1050 and a superconducting coil 1070 in the bottom of sled 1050, respectively, to provide high centripetal force directed radially inward of the acceleration ring. A motor stator 1080 above the top track and a motor stator 1090 below the bottom track are arranged to provide sled propulsion with minimal or no change in vertical gap as sled speed increases. In some examples, a low-speed support system as described above, such as, but not limited to sliders or wheels (not shown) are provided on the sled or the guideway (or both) to provide vertical positioning of the sled 1050 until take-off speed is reached. Other aspects of the configuration and operation of the sled 1050 and the guideway in FIG. 10 may be similar to those described above with regard to the examples in FIGS. 3, 4 and 5A-E.

In comparison to a sheet levitation system as described with reference to FIGS. 2 and 3, the null-flux design exhibits the following advantages:
The motor can be more effective due to the constant, narrow gap between the sled coils and the guideway stator coils.
The load path in the sled is simpler, which can result in a lighter sled.
If the sled superconductor quenches, the vehicle crashes into tunnel wall, but not into tracks, thus minimizing potential damage to the tracks.
A potential for higher L/D ratio than a sheet track.
Compatibility with simple dynamic control coils to ensure stability of the vehicle (described below).

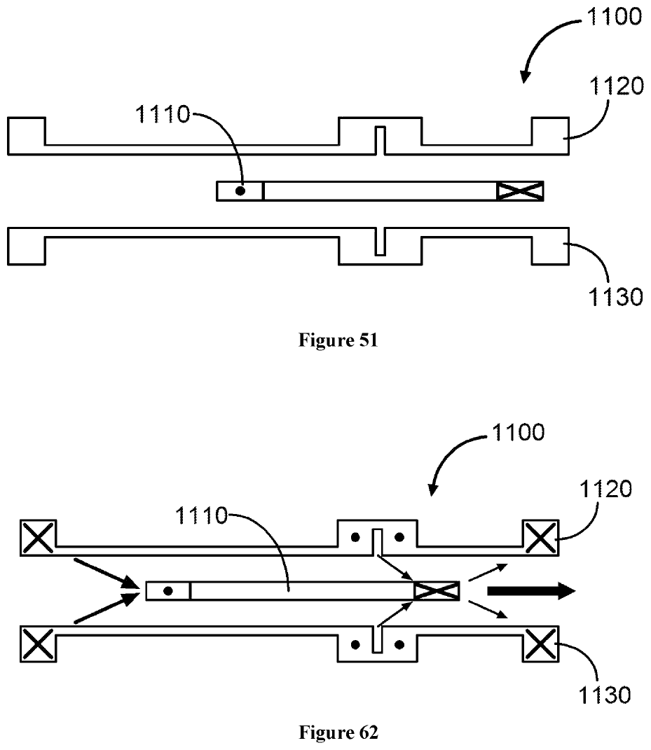

FIGS. 11 and 12 are cross-section views of the track coils and a vehicle coil according to a further embodiment of a Launch Ring electrodynamic launching system 1100 that uses a null-flux EDS configuration. The configuration in FIG. 11 may include or operate with a guideway as described with regard to FIG. 10 or other suitable guideways. However, in the system embodiment of FIG. 11, a thin sled uses a single set of superconducting coils 1110 that interact with two null-flux suspension tracks as described herein, including a first track 1120 above the sled and a second track 1130 below the sled. The drawing of FIG. 11 shows the position of the sled coil when the sled is stationary or moving at a low speed. As sled speed increases, the sled is forced toward the radially outer (left) side of the guideway by centrifugal force, inducing currents in both null-flux suspension tracks 1120 and 1130. Those currents create magnetic fields that provide centripetal force to counteract the centrifugal force and resist further radial movement of the sled and that increase in magnitude (resulting in an increased centripetal force) as the sled speed and centrifugal force on the sled increases.

FIG. 12 shows the position of sled coil 1110 when the sled is moving at high speed. It also shows how the induced currents in null-flux suspension coils 1120 and 1130 interact with the currents in sled coil 1110 to provide the required levitation forces. The main force generated by the null flux coils is a radial force used to maintain the centripetal acceleration of the vehicle, which can be up to several thousand G's in some embodiments. The relatively small (1 G) vertical levitation force required to counteract gravity results from the vehicle flying slightly closer to the lower set of coils, so the vertical forces from the top 1120 and bottom 1130 coils do not quite balance, and the imbalance counteracts the gravity force on the vehicle.

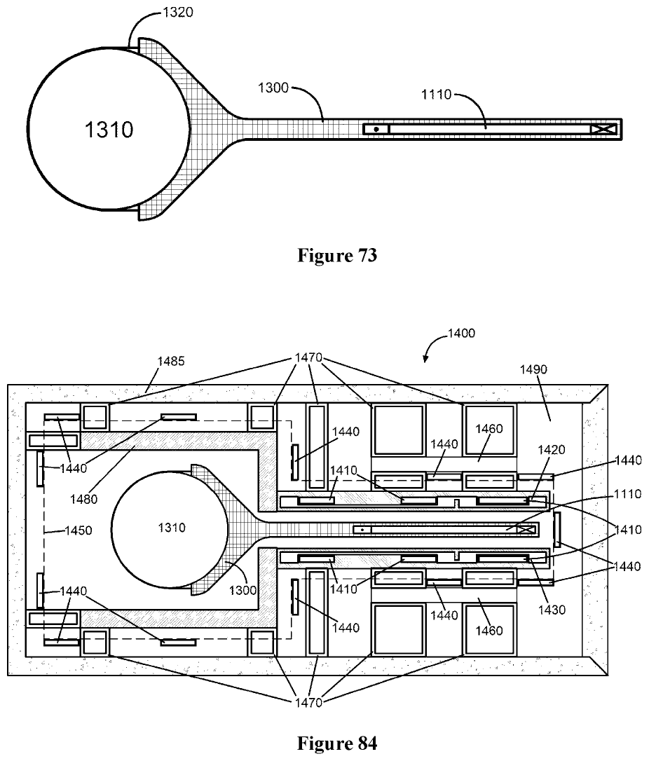

FIG. 13 shows a cross-section of a further example of a maglev sled 1300 that may be used with a null-flux accelerator system embodiment of FIGS. 11 and 12 described above, or of FIG. 14 described below. The example embodiment of FIG. 13 can be configured to be more compact and weight-efficient than the embodiment in FIG. 10. The sled in FIG. 13 includes sled coil 1110 and carries a payload 1310. A sling 1320 prevents payload 1310 from detaching from the sled 1300 until a launch speed is attained and the sling 1320 is cut or otherwise detached from the sled 1300. In other embodiments sling 1320 may be replaced by different mechanisms to constrain the payload 1310 until separation is desired.

FIG. 14 shows a cross-section view of an example of a further embodiment of a Launch Ring electrodynamic launching system 1400 that includes the sled 1300 of FIG. 13 and uses a null-flux EDS configuration. The system 1400 in FIG. 14 includes many features of the sheet levitation accelerator system 1000 shown in FIG. 10 such as, but not limited to a heat shield, support struts 1020, and cooling channels 1410. The system 1400 includes null-flux suspension tracks 1420 and 1430 as described with reference to FIGS. 11 and 12. The primary cooling channels 1410 are connected to a source of a low temperature cryogen such as, but not limited to liquid helium, to cool the null-flux suspension tracks 1420 and 1430 to the temperature required to achieve the conductance appropriate for the chosen design speed of any desired accelerator or launch profile. The system 1400 may include secondary cooling channels 1440 located in heat-transfer proximity to a cold shield 1450. The secondary cooling channels 1400 may be connected to a source of a higher temperature cryogen such as, but not limited to liquid nitrogen, to reduce the overall accelerator temperature, as discussed above. Motor stator and guidance components 1460 (described below) may be located above the top track and below the bottom track. Support struts 1470, fabricated of material with high strength and low thermal conductance, such as but not limited to carbon fiber, are located within an outer tunnel wall structure 1485 of the guideway, and separate an internal tunnel wall structure 1480 from the outer tunnel wall structure 1485. In certain examples, the space between the internal tunnel wall structure 1480 and the outer tunnel wall structure 1485 is filled with insulation 1490.

In the example of FIG. 14, the Launch Ring electrodynamic suspension null-flux track provides a centripetal restoring force that increases as the vehicle velocity increases and is locally proportional to the vehicle's displacement from the guiding centerline (flux-nulling point) of each track. In certain track examples described above, there is a range of roughly 6 cm over which the centripetal force from one track on one vehicle coil increases almost linearly from zero to 3 meganewtons. This produces a stable suspension in the displacement direction (centripetal) with very high positive stiffness.

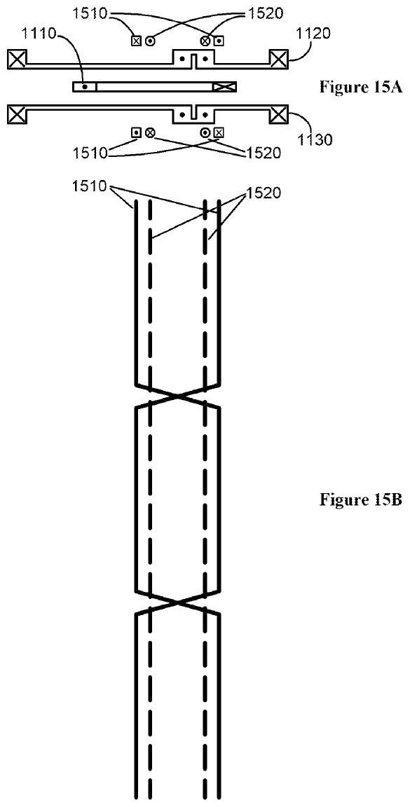

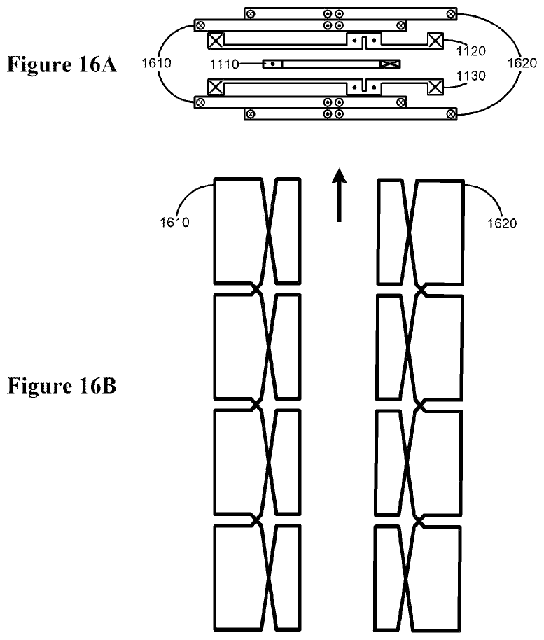

But positive stiffness in the centripetal direction may not necessarily prevent the growth of unstable radial oscillations over time, nor provide stability and damping in the other coordinates of interest, including vertical motions (in the direction of gravity) as well as yaw, pitch, and roll rotations of the vehicle. Accordingly, particular embodiments may be configured to provide this stability and damping. For example, any of the examples described herein may include damping cables 1510 and 1520 as shown in FIGS. 15A and 15B, each of multi-strand wire such as, but not limited to Litz wire. FIG. 15A shows a cross-section view and FIG. 15B shows a top view of a damping cable configuration employing the damping cables 1510 and 1520, according to an example embodiment. The damping cables 1510 provide vertical, centripetal and roll damping. The damping cables 1520 provide pitch and yaw damping.

As described previously, currents induced into the multi-strand wire (or Litz-wire) null-flux track by the magnetic fields of the passing sled coils provide a strong centripetal force on the sled coils. Currents in the damping cables 1510 and 1520 are normally near zero but are actively driven by control circuits from a current source (not shown) connected to those cables, to damp out vehicle oscillations about a desired equilibrium position. In FIGS. 15A and 15B, the currents in the vertical, centripetal and roll damper cables 1510 are being driven such that their horizontal forces and roll forces on the vehicle cancel, while their vertical forces combine to push the vehicle downward. Reversing these currents would provide an upward force. By permuting the currents in other combinations, the damper cable 1510 can provide a net horizontal force, net roll force, or a combination of all three. The currents shown in pitch and yaw damper cables 1520 provide a net upward pitch torque to the vehicle. Reversing the currents would provide a downward pitch torque, while running all four currents in the same direction would provide a torque in the yaw-direction.

In certain examples, the damping cables are configured to provide up to 2×10⁵ Newtons of force for critical damping in a centripetal suspension with 1 Meganewton/cm stiffness and a maximum excursion of 1 mm from equilibrium. This requires 10⁵ N per sled coil, or an estimated 25 kilo-amp on each of the four centripetal damping cables. For damping cables made of oxygen-free, high conductivity (OFHC) copper wire at 30 Kelvin, the power losses can be about 1 kilowatt per meter. Accordingly, for certain embodiments, it may be too costly to run each damping cable as a single loop all the way around a 20-kilometer Launch Ring (20 megawatts per damping cable). Therefore, in particular examples, the damping cables are segmented into regions no longer than a defined length such as, but not limited to 100 meters. Control electronics are provided to actively switch on each segment of the damping cables, as the vehicle approaches the segment, to limit the damping losses to, for example, about half a megawatt.

Another embodiment of a guidance system that may be included in any of the examples embodiments described herein is illustrated in FIGS. 16A and 16B, where FIG. 16A shows a cross-section view and FIG. 16B shows a top-down view of the guidance system. The guidance system in FIGS. 16A and 16B is similar to the system shown in FIGS. 15A and 15B, but provides a “semi-passive” version of the vertical, centripetal, and roll dampers using four overlapping sets of smaller null-flux coils (1610 and 1620) instead of the four actively driven zig-zag cables of FIGS. 15A and 15B. The semi-passive version would not require 100-kilowatt power supplies synchronized to the 5 kHz motor commutation frequency, so there are significant savings on power supplies for damping. Instead, sets of interconnected null-flux loops 1610 and 1620, from 40-100 meters long, are actively switched into an open or closed-circuit configuration as the vehicle approaches, so the vehicle fields would induce the currents necessary to drive the dampers in phase. Four sets of small null-flux coils could provide semi-passive damping. A high-power solid-state switch connects whichever actuators are needed to generate the damping force.

The actuators are series-connected null-flux coils, with approximately 40 coils connected in series. This requires 40 times less control switches to turn the coils on and off than would be required for discrete null-flux coils. A single coil would have large, induced currents, forces and drag. Placing 40 of them in series increases the reactance by 40 and decreases the currents, drag, and forces by a factor of 40, while still providing enough force to make an adequate control actuator.

Various embodiments described herein include control electronics associated with one or more of the guideway, the vehicle (sled) or the payload, that control the performance of various processes or tasks described above including, but not limited to the control of sled speeds, sled fly heights, damping cable currents, payload release mechanisms, hatch motions, sabot release, rocket engine ignition, cooling system operations, and coil charging operations. In various embodiments, such control electronics may include one or more computers or electronic processors and associated electronics configured to perform operations, processes and tasks described herein, for example, through the execution of computer readable code read from computer-readable storage media. For example, in various embodiments, one or more computer-readable storage mediums store one or more computer programs that, when executed by a device, cause the one or more computers or electronic processors to perform operations, processes or tasks as described with respect to the systems and system components described in the above embodiments.

Such computer-readable storage media can be any available non-transitory storage media that can be accessed, for example, by a computer or a processor. By way of example, such computer-readable storage media can comprise semiconductor memory, flash memory, hard disks, optical disks such as compact disks (CDs) or digital versatile disks (DVDs), magnetic storage, random access memory (RAM), read only memory (ROM), and/or the like. Combinations of those types of memory are also included within the scope of computer-readable storage media. Computer-executable program code may comprise, for example, instructions and data which cause a computer or processing machine to perform certain functions, calculations, actions, or the like.

The embodiments disclosed herein are to be considered in all respects as illustrative, and not restrictive. The present disclosure is in no way limited to the embodiments described above. Various modifications and changes may be made to the embodiments without departing from the spirit and scope of the disclosure. Various modifications and changes that come within the meaning and range of equivalency of the claims are intended to be within the scope of the disclosure.

1. An electrodynamic launching system comprising:
a guideway including at least one track of ultra-conducting material and having a lengthwise dimension;
a vehicle having at least one electrically conductive coil arranged to interact with each electrically conductive track to induce electrical current in each track as the vehicle is moved along the lengthwise dimension of the track, wherein the vehicle is configured to hold a payload;
at least one drive device configured to drive the vehicle along the lengthwise dimension of the at least one track at one or more first velocities that induce electrical current in the at least one track sufficient to levitate the vehicle and to inhibit collision of the vehicle with the guideway and the at least one track by electrodynamic suspension as the vehicle is moved along the lengthwise dimension of the at least one track, and to drive the vehicle at a launch velocity to launch the vehicle from the guideway, wherein the launch velocity is at least as great as the one or more first velocities;
a release mechanism configured to release the payload from the vehicle in a controlled manner, to launch the payload from the guideway while the at least one drive device drives the vehicle at a launch velocity.

2. A system as recited in claim 1, wherein the electrically conductive track comprises at least one array of null-flux coils.

3. A system as recited in claim 2, wherein each null-flux coil comprises at least one wire of aluminum having a purity of at least 99.9%, or of copper having a purity of at least 99.9%.

4. A system as recited in claim 2, wherein each array of null-flux coils comprises a plurality of overlapping or nested figure-8 shaped coils arranged along the lengthwise dimension of the track.

5. A system as recited in claim 2, wherein each null-flux coil comprises a flat wire.

6. A system as recited in claim 2, wherein each null-flux coil comprises a multistrand wire.

7. A system as recited in claim 1, wherein:
the at least one electrically conductive track comprises a first array of null-flux coils arranged along the lengthwise dimension, and second array of null-flux coils arranged along the lengthwise dimension;
the at least one electrically conductive coil of the vehicle comprises a first coil arranged to induce electrical current into the first array of null-flux coils, and a second coil arranged to induce electrical current into the second array of null-flux coils as the vehicle is moved along the lengthwise dimension of the tracks.

8. A system as recited in claim 7, wherein the vehicle is located between the first and second arrays of null-flux coils.

9. (canceled)

10. A system as recited in claim 1, wherein the guideway has a circular or curved shape and the at least one electrically conductive track is configured to impart, by the electrodynamic suspension, a radially inward directed force on the vehicle, relative to the circular or curved shape of the guideway.

11. A system as recited in claim 1, wherein:
the electrically conductive track comprises at least one electrically conductive sheet of ultra-conducting material extending along the lengthwise dimension of the track;
the at least one electrically conductive coil comprises superconducting material and is arranged to induce an image coil in the electrically conducive sheet as the vehicle is moved along the lengthwise dimension of the track; and
the at least one electrically conductive coil interacts with the image coil to provide a repulsion force sufficient to levitate the vehicle and to inhibit collision of the vehicle with the guideway or with the at least one track by electrodynamic suspension as the vehicle is moved along the lengthwise dimension of the track.

12. A system as recited in claim 1, wherein:
the at least one electrically conductive track comprises an upper conductive track of ultra-conducting material arranged at a downward-facing angle relative to a horizontal plane, and a lower conductive track of ultra-conducting material arranged at an upward-facing angle relative to the horizontal plane; and
the at least one electrically conductive coil of the vehicle comprises a first coil of superconducting material arranged to induce electrical current into the upper conductive track, and a second coil of superconducting material arranged to induce electrical current into the lower conductive track as the vehicle is moved along the lengthwise dimension of the tracks.

13. A system as recited in claim 10, wherein the at least one electrically conductive track further comprises a third conductive track arranged vertically below the vehicle, and wherein the at least one electrically conductive coil of the vehicle comprises a third coil arranged to induce electrical current into the third conductive track as the vehicle is moved along the lengthwise dimension of the tracks at the one or more first velocities.

14. A system as recited in claim 1, wherein the guideway is an enclosed structure containing the at least one electrically conductive track, and wherein the at least one drive device is configured to drive the vehicle within the enclosed structure of the guideway at a velocity to induce electrical current in the at least one electrically conductive track sufficient to inhibit the vehicle from colliding with an inner surface of the guideway and with the at least one electrically conductive track by electrodynamic suspension when the vehicle is moved along the lengthwise dimension of the tracks.

15. A system as recited in claim 1, wherein:
the at least one electrically conductive coil of the vehicle comprises at least one coil made of a superconductor material, the vehicle further including at least one cooling duct configured to carry a coolant fluid to cool the at least one electrically conductive coil to a superconducting operating temperature;
the at least one electrically conductive track comprises an ultra-conducting material, the guideway further including a cooling system to cool the ultra-conducting material to an ultra-conducting temperature.

16. (canceled)

17. (canceled)

18. A method of launching a vehicle with an electrodynamic launching system, the method comprising:
providing a guideway including at least one track of ultra-conducting material and having a lengthwise dimension;
arranging a vehicle having at least one electrically conductive coil to induce electrical current in each electrically conductive track as the vehicle is moved along the lengthwise dimension of the track;
holding a payload on the vehicle;
driving the vehicle with at least one drive device along the lengthwise dimension of the at least one track at one or more first velocities to induce electrical current in the at least one track sufficient to levitate the vehicle and to inhibit collision of the vehicle with the guideway by electrodynamic suspension as the vehicle is moved along the lengthwise dimension of the at least one track, and at a launch velocity to launch the vehicle from the guideway, wherein the launch velocity is at least as great as the one or more first velocities;
controlling a release mechanism to release the payload from the vehicle in a controlled manner, to launch the vehicle from the guideway while the at least one drive device drives the vehicle at a launch velocity.

19. A method as recited in claim 18, wherein the electrically conductive track comprises at least one array of overlapping null-flux coils, and wherein each null-flux coil comprises at least one wire of aluminum having a purity of at least 99.9%, or of copper having a purity of at least 99.9%.

20. A method as recited in claim 18, wherein:
the electrically conductive track comprises at least one electrically conductive sheet of ultra-conducting material extending along the lengthwise dimension of the track;
the at least one electrically conductive coil comprises superconducting material and is arranged to induce an image coil in the electrically conducive sheet as the vehicle is moved along the lengthwise dimension of the track; and
the method further comprises providing a repulsion force sufficient by the at least one electrically conductive coil interacting with the image coil, to levitate the vehicle and to inhibit collision of the vehicle with the guideway or with the at least one track by electrodynamic suspension as the vehicle is moved along the lengthwise dimension of the track.

21. A system as recited in claim 1, wherein:
the at least one electrically conductive track comprises an upper conductive track of ultra-conducting material arranged at a downward-facing angle relative to a horizontal plane, and a lower conductive track of ultra-conducting material arranged at an upward-facing angle relative to the horizontal plane; and
the at least one electrically conductive coil of the vehicle comprises a coil of superconducting material.
